(19) United States
(12) Patent Application Publication
(10) Pub. No.: US 2015/0293615 A1
(43) Pub. Date: Oct. 15, 2015

(54) HYBRID PEN DEVICE AND METHOD

(71) Applicant: Maxim Integrated Products, Inc., San Jose, CA (US)

(72) Inventors: Stephen C. Gerber, Austin, TX (US); Ali Ekici, Los Gatos, CA (US); Daniel S. Christman, Campbell, CA (US)

(21) Appl. No.: 14/497,684

(22) Filed: Sep. 26, 2014

Related U.S. Application Data
(60) Provisional application No. 61/977,127, filed on Apr. 9, 2014.

(51) Int. Cl. G06F 3/0354; G06F 3/041; G06F 3/038

(52) U.S. Cl. CPC G06F 3/03545; G06F 3/038; G06F 3/0416

(57) ABSTRACT

A hybrid pen device and methods are described that include using active and passive technologies in a single hybrid pen. In implementations, the hybrid pen device includes an electronic pen assembly, including a pen body having a distal end and a proximal end, an electronic coil housed within the pen body in the proximal end, the electronic coil configured to be placed proximate to a touch screen device, an electronic switch housed within the pen body, the electronic switch configured to periodically activate a signal, and a battery electronically coupled to the electronic coil and the electronic switch.

### BACKGROUND

Many electrical devices incorporate touchscreen type displays. A touchscreen can include a display that detects the presence, location, and/or pressure of a touch within the display area, generally by a finger, hand, stylus, pen, or other pointing device. The touchscreen enables a user to interact with a display panel directly without requiring any intermediate device, instead of indirectly with a mouse or keyboard. Touchscreens can be implemented in computers or as terminals to access networks.

### SUMMARY

A hybrid pen device and methods are described that include using active and passive technologies in a single hybrid pen. In implementations, the hybrid pen device that employs example techniques in accordance with the present disclosure includes an electronic pen assembly, including a pen body having a distal end and a proximal end, an electronic coil housed within the pen body in the proximal end, the electronic coil configured to be placed proximate to a touch screen device, an electronic switch housed within the pen body, the electronic switch configured to periodically activate a signal, and a charge storage device electronically coupled to the electronic coil and the electronic switch. Additionally, a method for using the hybrid pen device that employs example techniques in accordance with the present disclosure includes implementing an electronic signal using an electronic coil housed within a pen body, where the electronic signal is configured to be received by a touchscreen device and periodically disabling the electronic signal using an electronic switch configured to periodically activate and periodically disable the electronic signal, where the electronic switch is electrically coupled to the electronic coil and a charge storage device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The detailed description is described with reference to the accompanying figures. The use of the same reference numbers in different instances in the description and the figures may indicate similar or identical items.

FIG. 1 is an isometric view illustrating an embodiment of a hybrid pen device that includes an electronic switch, in accordance with an example implementation of the present disclosure.

FIG. 2 is an isometric view illustrating a touchscreen device configured to be used with a hybrid pen device that includes an electronic switch, in accordance with an example implementation of the present disclosure.

FIG. 3 is an environment view illustrating an embodiment of an electronic pen assembly that includes an electronic switch, in accordance with an example implementation of the present disclosure.

FIG. 4 is a flow diagram illustrating an example process for utilizing a hybrid pen device that includes an electronic switch, such as the hybrid pen device illustrated in FIGS. 1 through 3.

FIG. 5 is a diagram illustrating example pen lines using the hybrid pen device shown in FIGS. 1 through 3.

### DETAILED DESCRIPTION

Overview

Passive pens for use with capacitive touch screens can include a writing instrument with a modest level of conductivity. One specific example of a passive pen may include a metal writing instrument with a 6-7 mm soft compressible head. A passive pen generally does not contain electronic component. A #2 pencil and/or a standard clickable ink pen may function as examples of a passive pen given a sufficient level of conductivity and touch system sensitivity. However, passive pens can be ineffective when the touch system or touchscreen lacks sensitivity

Active pens generally contain one or more electronic components within a writing instrument having a metal tip. An active pen may induce a greater level of “signal” with which to overcome the low sensing sensitivity of a touch system. An active pen can replicate a signal produced by a finger. Additionally, an active pen may include an identification or encoding/modulation in order to further improve system sensitivity or identification of the expected pen.

Mobile handsets and tablets with a touchscreen capability often utilize an active pen (stylus) to provide users with writing instrument functionality for note taking, drawings, texting, and artwork, etc. An active pen, such as that described above, can provide benefits to the user versus using finger-touch and/or a passive pen. However, active pens have limitations, such as the inability to sense accurate tip width, such as when a pen has a compressible soft tip. Additional shortcomings may include positional error due to the angle of the pen, parallax, a burdensome downward mechanical force requirement, poor artistic lift capability for art applications, and/or poor battery life.

Accordingly, a hybrid pen device and methods are described that include using both active and passive technologies in a single hybrid pen. In implementations, a hybrid pen device that employs example techniques in accordance with the present disclosure includes an electronic pen assembly, including a pen body having a distal end and a proximal end, an electronic coil (or electrode) housed within the pen body in the proximal end, where the electronic coil is configured to be positioned proximate and/or adjacent to a touch screen device during use, an electronic switch housed within the pen body, the electronic switch configured to periodically activate and deactivate a signal, and a charge storage device electronically coupled to the electronic coil and the electronic switch. Additionally, a method for using the hybrid pen device that employs example techniques in accordance with the present disclosure includes implementing an electronic signal using an electronic coil housed within a pen body, where the electronic signal can be configured to be received by a touchscreen device, and periodically disabling the electronic signal using an electronic switch configured to periodically activate and periodically disable the electronic signal, where the electronic switch is electrically coupled to the electronic coil and a charge storage device.

The hybrid pen device can provide many benefits for a touchscreen device user because of both active and passive sensing functionality. For example, the hybrid pen device can provide true tip size sensing (particularly useful with soft/compressible tips); eliminate tip location error induced by the angle of the pen; improve parallax correction when tip is in contact with a touch screen surface; surface contact detection without the need for a mechanical force or optical switch; zero-force contact recognition; artistic or calligraphic flair capability during movements with lift (many existing solutions include a mechanical force or optical switch that halts detection when the pen lifts from the surface); and/or battery life extension. The hybrid pen device can provide these advantages without compromise to existing active pen benefits.

Example Implementations

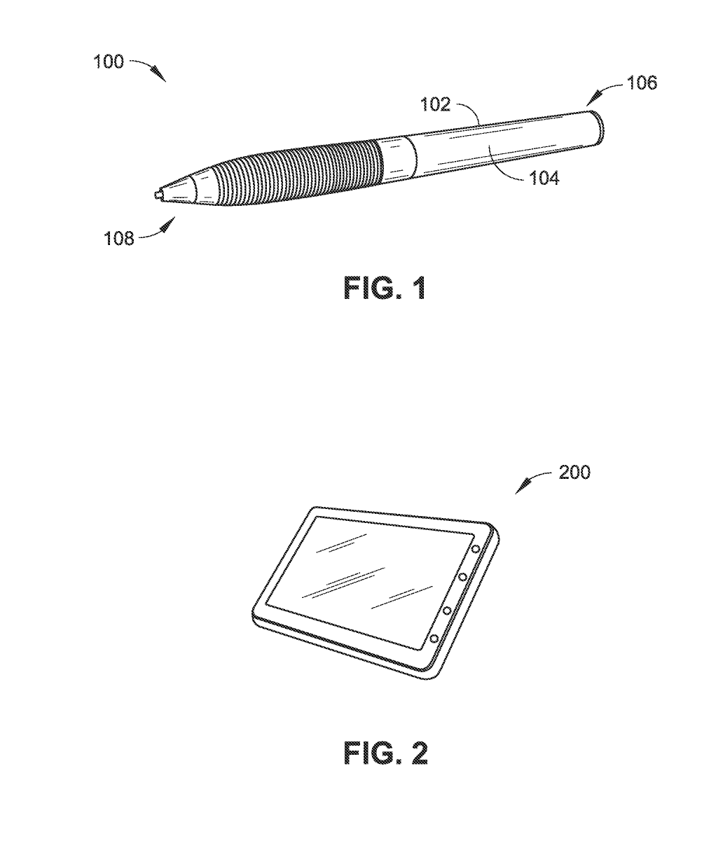

FIG. 1 illustrates a hybrid pen device 100 in accordance with an example implementation of the present disclosure. As shown in FIG. 1, the hybrid pen device 100 can include an electronic pen assembly 102 having a pen body 104. In implementations, the pen body 104 includes a body structure that is configured to function as a writing implement, for example the cylindrical-shaped assembly shown in FIG. 1. The pen body 104 can have a distal end 106 and a proximal end 108. In embodiments, the proximal end 108 can be the end of the hybrid pen device 100 configured to be placed proximate to a touch screen device 200, an example of which is illustrated in FIG. 2. A touchscreen device 200 can include an electronic visual display that a user can control through simple or multi-touch gestures by touching the screen with the hybrid pen device 100. Some examples of a touchscreen device can include a smartphone, a tablet computer, an all-in-one personal computer, an interactive table, and/or a game console. Additionally, touchscreen device 200 includes circuitry configured to detect a hybrid pen device 100 signal. This circuitry can include a processor, memory, a touchscreen, a communications interface, and/or sensors configured for sensing the hybrid pen device 100 signal.

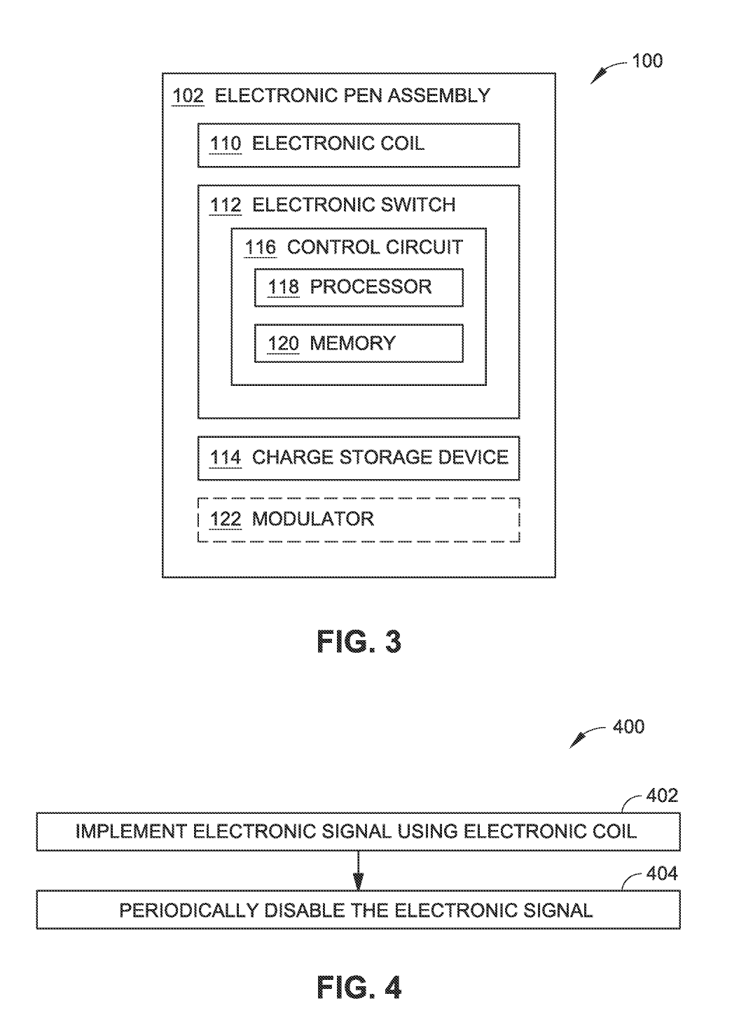

FIG. 3 illustrates an electronic pen assembly 102. In implementations, the electronic pen assembly 102 can include an electronic coil 110. In some implementations, the electronic coil 110 can be disposed in the proximal end 108 of the pen body 104. The electronic coil 110 can include an electromagnetic coil, which can further include an electrical conductor such as a wire and/or metal in the shape of a coil. An electronic coil 110 can pass an electric current through the wire of the coil to generate a magnetic field, which can be detected by sensors or other detection devices in a touchscreen device 200. In an additional embodiment, the electronic coil 110 can include an electrode, which can further include an electrical conductor through which electricity enters or leaves an object, substance, or region. In other examples, the electronic coil 110 can include a conductor and/or an antenna. One specific example of an electronic pen assembly 102 can include a proximal end 108 that further includes a tip (e.g., compressible) that provides a line thickness on a touchscreen device 200 that varies with the amount of pressure applied by a user.

As illustrated in FIG. 3, the electronic pen assembly 102 includes an electronic switch 112 coupled to the electronic coil 110 and/or a charge storage device 114. In implementations, the electronic switch 112 functions to periodically disable and/or enable electronic signal transmission from the hybrid pen device 100. The electronic switch 112 can include an electronic component (e.g., an automated switch) configured to break an electrical circuit. In embodiments, the electronic switch 112 can be automated and controlled by a control circuit 116. In some implementations, control circuit 116 can include a processor 118 and/or memory 120. In one specific embodiment, an electronic switch 112 includes an automated switch configured to periodically and/or alternately disable and enable an electronic signal transmission at predetermined time intervals (e.g., automatic active mode, on-off keying). In an additional embodiment, the electronic switch 112 may be configured to only include manual switching capability or include manual switching capability in addition to automated switching capability. In one example, the hybrid pen device 100 includes a switch that can be manually switched (e.g., by a user's finger). Another example of an electronic switch 112 can include a gain switch. In this example, the signal gain can be adjusted depending on the user's needs. Additionally, the touchscreen device 200 can include an electronic switch 112, such as a gain switch, where the electronic switch 112 is configured to be coupled with a touchscreen.

In some implementations, the electronic pen assembly 102 can include a modulator 122. The modulator 122 can be electronically coupled to the electronic coil 110, the electronic switch 112, and/or a charge storage device 114. In these implementations, the modulator 122 can be physically separate from or can be physically included in the electronic pen assembly 102 and/or in control circuit 116. The modulator 122 (frequency modulator) can include a device configured to modulate and/or vary one or more properties of a periodic waveform (e.g., carrier signal) with a modulating signal that can include information to be transmitted (e.g., signal from the hybrid pen device 100 that is configured to be detected by a touchscreen device 200). In an embodiment, the modulator 122 can be configured to convey the message signal (e.g., from the hybrid pen device 100) inside another signal that can be physically transmitted. In some specific embodiments, the modulator 122 can include a demodulator and/or have demodulation capability. Demodulation can include extracting the original information-bearing signal from a modulated signal. One example of this specific embodiment can include a hybrid pen device 100 and/or electronic pen assembly 102 receiving a signal from a touchscreen device 200, such as an information and/or identification signal. In one specific implementation, the modulator 122 can be configured to convey a signal with different modulation and/or keying methods (e.g., PSK, FSK, ASK, OOK, etc.) that result in different waveforms (e.g., square, sine, triangle, sawtooth, etc.) further resulting in conveying different signals (e.g., differing signal intensity, active signal time duration, absence of signal duration, etc.) from the hybrid pen device 100 to the touchscreen device 200. For example, one signal from the modulator 122 and/or the hybrid pen device 100 can include a skip mode where the active signal from the hybrid pen device 100 can periodically skip implementing the active signal. In other examples, the modulator 122 can implement a signal duty cycle (e.g., an active signal is sent only for a portion of the time, such as 30%). In yet other examples, the modulator 122 can implement an active signal that varies in intensity with respect to time. For example, the modulator 122 can cause the hybrid pen device 100 to repeatedly send a signal to a touchscreen device 200 that ramps up in intensity from 0% to 100% for one second and then decreases in intensity from 100% to 0% for one second. It is contemplated that the modulator 122 can convey other waveforms and cause the electronic pen assembly 102 to implement other types of signals configured to be detected by a touchscreen device 200.

A processor 118 can provide processing functionality for the hybrid pen device 100 and electronic pen assembly 102 and may include any number of processors, micro-controllers, or other processing systems and resident or external memory for storing data and other information accessed or generated by the electronic pen assembly 102. The processor 118 may execute one or more software programs which implement techniques described herein. The processor 118 is not necessarily limited by the materials from which it is formed or the processing mechanisms employed therein and, as such, may be implemented via semiconductor(s) and/or transistors (e.g., electronic integrated circuits (ICs)), and so forth.

The memory 120 can include computer-readable media that provides storage functionality to store various data associated with the operation of the electronic pen assembly 102, such as software programs and code segments, or other data to instruct the processor 118 and other elements of the electronic pen assembly 102 to perform the functionality described herein. Although a single memory 120 is shown in FIG. 3, a wide variety of types and combinations of memory may be employed. The memory 120 may be integral with the processor 118, stand-alone memory, or a combination of both. The memory 120 may include, for example, removable and non-removable memory elements, such as random-access memory (RAM), read-only memory (ROM), flash memory (e.g., a secure digital (SD) card, a mini-SD card, and/or a micro-SD card), magnetic memory, optical memory, universal serial bus (USB) memory, and so forth. In implementations, the memory may include an algorithm configured to periodically enable/disable a signal from the hybrid pen device 100 and the electronic coil 110. In some embodiments, an algorithm within the sensing system of the touchscreen device 200 can identify and treat the two hybrid pen device 100 modes (e.g., active and passive) in order to add new features and improve the performance of the hybrid pen device 100. The memory 120 can be electronically coupled to processor 118 using a communication interface, which can include wired or wireless capability. The communication interface can include wiring and/or wireless communication devices.

As illustrated in FIG. 3, the electronic pen assembly 102 can include a charge storage device 114. In implementations, the charge storage device 114 can include a battery and/or a capacitor configured to store energy for operating the electronic pen assembly 102. In implementations, a battery can include one or more electrochemical cells that convert stored chemical energy into electrical energy. In one embodiment, the electronic pen assembly 102 includes a charge storage device 114 configured to be disposed within the pen body 104 and supply power to the electronic switch 112 and/or electronic coil 110. In embodiments, the charge storage device 114 may be electrically coupled to the electronic switch 112 and the electronic coil 110 in order to supply power. In a specific embodiment, a battery implemented in the electronic pen assembly 102 can be rechargeable and may include a device configured to be electrically coupled to a recharge power source, such as a power jack. In other embodiments, the battery can be configured to be disposable and/or replaceable. In a specific embodiment, the charge storage device 114 can be configured to charge using inductive charging capability. In this embodiment, the charge storage device can include a charging coil configured to interact with and/or receive charge from an inductive charging device.

Example Processes

FIG. 4 illustrates an example process 400 that employs a hybrid pen device and touchscreen device 200, such as the hybrid pen device 100, electronic pen assembly 102, and touchscreen device 200 shown in FIGS. 1 through 3.

In the process 400 illustrated, an electronic signal is implemented using an electronic coil (Block 402). As shown in FIG. 4, implementing an electronic signal can include using an electronic coil 110, electronic pen assembly 102, and/or and electronic switch 112 included in the hybrid pen device 100. In an embodiment, implementing an electronic signal can include using a control circuit 116 in the electronic pen assembly 102 to cause an electronic coil 110 to transmit an electronic signal from the hybrid pen device 100, where the electronic signal is configured to be received by a corresponding touchscreen device 200. In this embodiment, the electronic signal can provide a signal configured to overcome a low sensitivity of a touchscreen device 200. In some embodiments, the electronic signal can include identification or encoding/modulation in order to improve touchscreen device 200 sensitivity. In additional embodiments, the electronic signal can provide identification information to the touchscreen device 200 for an expected, compatible, and/or assigned hybrid pen device 100.

Next, the electronic signal is periodically disabled and enabled (Block 404). In an embodiment, electronic switch 112 and/or control circuit 116 can periodically disable and subsequently enable an electronic signal from the hybrid pen device 100. In this fashion, the hybrid pen device 100 can alternately implement both an active and a passive implementation. When the signal is disabled by electronic switch 112, the resulting passive mode can function to reduce energy consumption as well as sensing tip width, etc. Periodically disabling and enabling the electronic signal using the electronic switch 112 can allow the touchscreen device 200 to detect a smaller signal in systems sensitive enough to detect small signals. In one specific implementation, the electronic switch 112 can change from an enable to a disable mode every 20 milliseconds (ms). In another specific implementation, the electronic switch 112 can change from an enable to a disable mode every 100 milliseconds (ms). In yet another embodiment, control circuit 116 can periodically enable an electronic signal configured to provide a position but not necessarily a line. Other time intervals used in implementing periodic disabling of a signal from the hybrid pen device 100 may also be utilized. For example, random time intervals can be implemented.

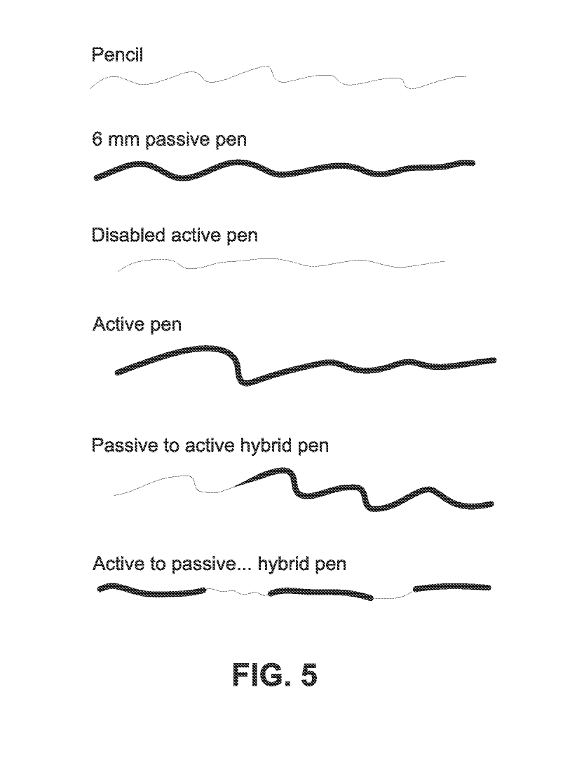

FIG. 5 illustrates example implementations of active and passive mode measurements of the hybrid pen device 100. The measurements illustrated are representative of the electronic signals a touchscreen device 200 may measure. The first two examples represent lines caused by and/or signals received by a touchscreen device 100 from a pencil and an example 6 mm passive pen, respectively. The second two examples represent an example disabled active pen and an active pen, respectively. The third two examples include a measurement manually switched from passive to active and an alternately switched active to passive pen mode, respectively.

The hybrid pen device 100 provides a pen and/or stylus for use with a touchscreen device 200 that alternately implements both an active and passive implementation in order to obtain the benefits of both an active and a passive type of pen within a single hybrid pen device 100. Rather than providing a constantly active pen, the hybrid pen device 100 periodically disables (and enables) the control circuit 116 and/or electronic switch 112 within the hybrid pen device 100 to allow a touchscreen system 200 to detect the small signal of a passive pen in systems sensitive enough to detect such small signals. The touchscreen system 200 can include algorithms within its control circuitry (e.g., processor, sensor(s), memory, etc.) to identify the differences between the passive signal and the active signal.

### CONCLUSION

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims

What is claimed is:

1. A hybrid pen device, comprising:
an electronic pen assembly, including
a pen body having a distal end and a proximal end,
an electronic coil housed within the pen body in the proximal end, where the proximal end is configured to be positioned proximate to a touch screen device during use of the hybrid pen device,
an electronic switch housed within the pen body, where the electronic switch is configured to periodically activate a signal, and
a charge storage device electronically coupled to the electronic coil and the electronic switch.

2. The hybrid pen device of claim 1, wherein the electronic coil includes at least one of a conductor and an antenna.

3. The hybrid pen device of claim 1, wherein the electronic switch includes control circuitry.

4. The hybrid pen device of claim 3, wherein the control circuitry includes at least one of a processor and a memory.

5. The hybrid pen device of claim 1, wherein the charge storage device includes at least one of a battery or a capacitor.

6. The hybrid pen device of claim 1, wherein the charge storage device includes a rechargeable battery device.

7. The hybrid pen device of claim 1, wherein the charge storage device includes inductive charging capability.

8. A process for using a hybrid pen device, comprising:
implementing an electronic signal using an electronic coil housed within a pen body, where the electronic signal is configured to be received by a touchscreen device and where the electronic signal is implemented using a control circuit; and
periodically disabling and periodically activating the electronic signal using an electronic switch configured to periodically activate and periodically disable the electronic signal, where the electronic switch is electrically coupled to the electronic coil and a battery.

9. The process of claim 8, wherein implementing the electronic signal includes implementing a signal duty cycle.

10. The process of claim 8, wherein the electronic coil is disposed in an end of the pen body configured to be disposed proximate to a touchscreen device.

11. A hybrid pen system, comprising:
a hybrid pen device including
an electronic pen assembly, including
a pen body having a distal end and a proximal end,
an electronic coil housed within the pen body in the proximal end, where the proximal end is configured to be positioned proximate to a touch screen device during use of the hybrid pen device,
an electronic switch housed within the pen body, where the electronic switch is configured to periodically activate an electronic signal, and
a charge storage device electronically coupled to the electronic coil and the electronic switch, and
a touchscreen device configured to detect the electronic signal from the hybrid pen device, where the hybrid pen device is configured to periodically activate and periodically disable the electronic signal.

12. The hybrid pen system of claim 11, where the electronic signal is transmitted from an electronic coil housed within the hybrid pen device.

13. The hybrid pen system of claim 12, where the electronic coil is disposed in the proximal end of the hybrid pen device.

14. The hybrid pen system of claim 11, where the electronic switch is configured to implement a signal duty cycle.

15. The hybrid pen system of claim 11, where the electronic switch is configured to implement a skip mode.

16. The hybrid pen system of claim 11, where the electronic switch is configured to be controlled by the touchscreen device.

17. The hybrid pen system of claim 11, wherein the charge storage device includes at least one of a battery or a capacitor.

18. The hybrid pen system of claim 11, wherein the charge storage device includes a rechargeable battery device.

19. The hybrid pen system of claim 11, wherein the charge storage device includes inductive charging capability.

20. The hybrid pen system of claim 11, further comprising a modulator.
